(19) United States
(12) Patent Application Publication
(10) Pub. No.: US 2012/0028164 A1
(43) Pub. Date: Feb. 2, 2012

(54) LITHIUM AIR BATTERY

(75) Inventors: Dong-joon LEE, Seoul (KR); Osamu YAMAMOTO, Tsu City (JP); Dong-min IM, Seoul (KR); Yasuo TAKEDA, Tsu City (JP); Nobuyuki IMANISHI, Tsu City (JP)

(73) Assignees: National University Corporation Mie Uinversity, Tsu City (JP); Samsung Electronics Co., Ltd., Suwon-si (KR)

(21) Appl. No.: 13/191,769

(22) Filed: Jul. 27, 2011

(30) Foreign Application Priority Data
Jul. 28, 2010 (KR) 10-2010-0072983
Jul. 15, 2011 (KR) 10-2011-0070665

(51) Int. Cl. H01M 8/10; H01M 4/90; H01M 4/96; H01M 8/08

(52) U.S. Cl. 429/482; 429/479; 429/491

(57) ABSTRACT

A lithium air battery including an aqueous electrolyte. In the lithium air battery, a lithium halide is included in the aqueous electrolyte in order to prevent lithium hydroxide and a solid electrolyte from reacting with each other so as to protect the negative electrode, thereby improving electrical characteristics of the lithium air battery.

### CROSS-REFERENCE TO RELATED APPLICATIONS

This application claims the benefit of Korean Patent Application Nos. 10-2010-0072983 and 10-2011-0070665, respectively filed on Jul. 28, 2010 and Jul. 15, 2011 in the Korean Intellectual Property Office, the disclosures of which are incorporated herein in their entirety by reference.

### BACKGROUND

1. Field

Aspects of the present disclosure relate to lithium air batteries, and more particularly, to lithium air batteries having a high energy density and electrical characteristics that are maintained even if the lithium air batteries are used for a long period of time.

2. Description of the Related Art

Lithium air batteries include a negative electrode in which lithium ions are intercalatable and deintercalatable, a positive electrode including oxygen as a positive active material and a redox catalyst of oxygen, and a lithium ion conductive medium between the positive electrode and the negative electrode. Lithium air batteries have a theoretical energy density of 3000 Wh/kg or greater which is about 10 times greater than that of lithium ion batteries. In addition, lithium air batteries are environmentally safe and have better stability than lithium ion batteries. Thus, lithium air batteries have been actively developed.

Lithium air batteries may use an aqueous electrolyte or a non-aqueous electrolyte as the lithium ion conductive medium. The non-aqueous electrolyte may be, for example, an organic solvent including a lithium salt. The aqueous electrolyte may be, for example, water including a salt.

### SUMMARY

Aspects of the present invention provide lithium air batteries that prevent an electrode from being damaged due to reaction products generated from an electrolyte, thereby improving electrical characteristics.

According to an aspect of the present invention, a lithium air battery includes a negative electrode in which lithium ions are intercalatable and deintercalatable; a lithium ion conductive solid electrolyte membrane; an aqueous electrolyte; and a positive electrode using oxygen as a positive active material, wherein the aqueous electrolyte includes lithium hydroxide and a lithium halide.

The lithium halide may include at least one halide selected from the group consisting of lithium fluoride (LiF), lithium chloride (LiCl), lithium bromide (LiBr), and lithium iodide (LH).

The lithium ion conductive solid electrolyte membrane may be disposed between the negative electrode and the positive electrode, and is formed on one surface of the negative electrode.

The lithium ion conductive solid electrolyte membrane may include a glass-ceramic solid electrolyte including a metal ion.

The lithium ion conductive solid electrolyte membrane may further include a high-molecular weight solid electrolyte.

The lithium ion conductive solid electrolyte membrane may include a stack structure of the glass-ceramic solid electrolyte and the high-molecular weight solid electrolyte.

The lithium halide dissolved in the aqueous electrolyte may have a concentration of about 0.1% to about 100% of the saturation concentration.

The lithium halide dissolved in the aqueous electrolyte may have a concentration of about 10% to about 100% of the saturation concentration.

The aqueous electrolyte may include lithium chloride (LiCl) having an amount of about 1 to about 83 parts by weight based on 100 parts by weight of water.

The negative electrode may include lithium metal, a lithium metal-based alloy, or a lithium intercalating compound.

The positive electrode may include a porous carbonaceous material.

The lithium air battery may further include a separator disposed between the lithium ion conductive solid electrolyte membrane and the positive electrode.

The positive electrode may further include an oxygen reduction catalyst.

The aqueous electrolyte may be disposed between the lithium ion conductive solid electrolyte membrane and the positive electrode using oxygen as the positive active material.

The aqueous electrolyte may be entirely or partially impregnated in the positive electrode.

The aqueous electrolyte may further include a non-aqueous electrolyte disposed between the negative electrode in which lithium ions are intercalatable and deintercalatable and the lithium ion conductive solid electrolyte membrane.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is an image of a surface of lithium-aluminum-titanium-phosphate (LATP) that is a lithium ion conductive solid electrolyte;

FIG. 2 is an image of a surface of the lithium ion conductive solid electrolyte of FIG. 1 after the lithium ion conductive solid electrolyte is treated by LiCl;

FIG. 3 is an image of a surface of the lithium ion conductive solid electrolyte of FIG. 1 after the lithium ion conductive solid electrolyte is treated by LiOH;

FIG. 4 is a schematic diagram of a lithium air battery according to an embodiment of the present invention; and

FIG. 5 is a graph showing results of electrical characteristics of cells that are measured in Experimental Example 2.

### DETAILED DESCRIPTION

Reference will now be made in detail to the present embodiments of the present invention, examples of which are illustrated in the accompanying drawings, wherein like reference numerals refer to the like elements throughout. The embodiments are described below in order to explain the present invention by referring to the figures.

A lithium air battery according to an embodiment of the present invention includes a negative electrode in which lithium ions are intercalatable and deintercalatable; a lithium ion conductive solid electrolyte membrane; an aqueous electrolyte; and a positive electrode using oxygen as a positive active material, wherein the aqueous electrolyte includes lithium hydroxide and a lithium halide.

A lithium air battery may use an aqueous electrolyte or a non-aqueous electrolyte as an electrolyte. When an aqueous electrolyte is used, a reaction occurs in the lithium air battery according to a reaction mechanism such as Reaction Scheme 1 below:

4Li+O₂+2H₂O->4LiOH E^{o}=3.45V. Reaction Scheme 1

That is, water contained in the aqueous electrolyte participates in a reaction in which lithium is generated from the negative electrode oxidized due to oxygen of the positive electrode to thus generate lithium hydroxide.

The lithium hydroxide is dissolved in the aqueous electrolyte. As the degree of discharge is increased, the concentration of the lithium hydroxide dissolved in the aqueous electrolyte is increased.

A hydroxyl group dissociated from the lithium hydroxide reacts with metal ions included in the lithium ion conductive solid electrolyte membrane that is used to protect the negative electrode, and thus, damages a structure of the lithium ion conductive solid electrolyte membrane as shown in Formula 1.

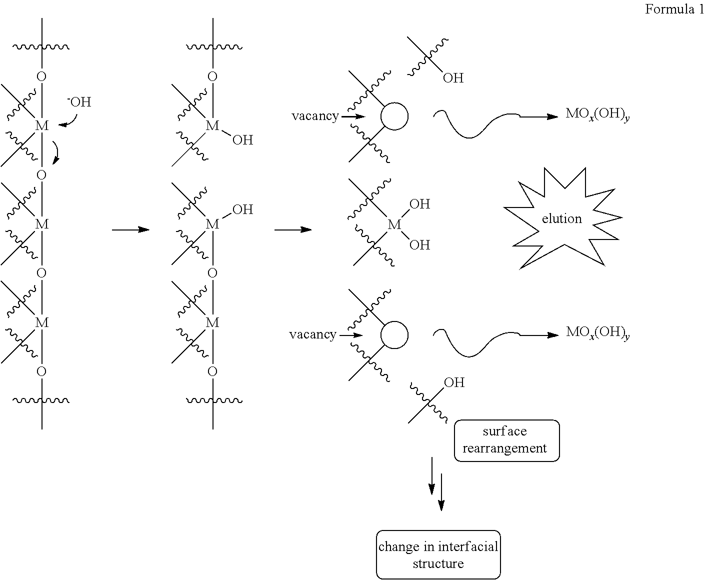

In Formula 1, M is a metal ion included in the lithium ion conductive solid electrolyte membrane. That is, the lithium ion conductive solid electrolyte membrane is formed on a surface of the negative electrode so as to serve as a protective layer preventing water contained in an aqueous electrolyte from directly reacting with lithium contained in the negative electrode. However, as an interfacial structure and components of the protective layer are changed due to lithium hydroxide that is a reaction product of the lithium air battery, resistance of the lithium ion conductive solid electrolyte membrane is increased, and thus conductivity of the lithium air battery is reduced to thus reduce the performance of the lithium air battery. However, if lithium halide is dissolved in the aqueous electrolyte, the degree of dissociation of LiOH is reduced, and thus the pH of the resulting solution is reduced.

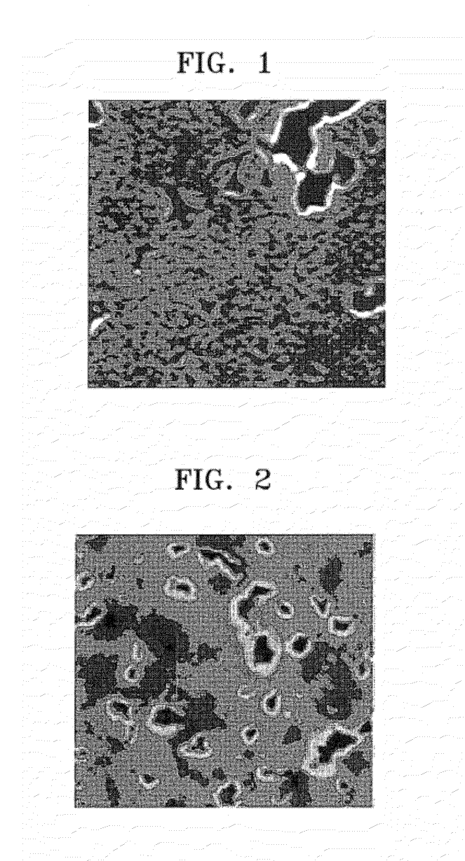

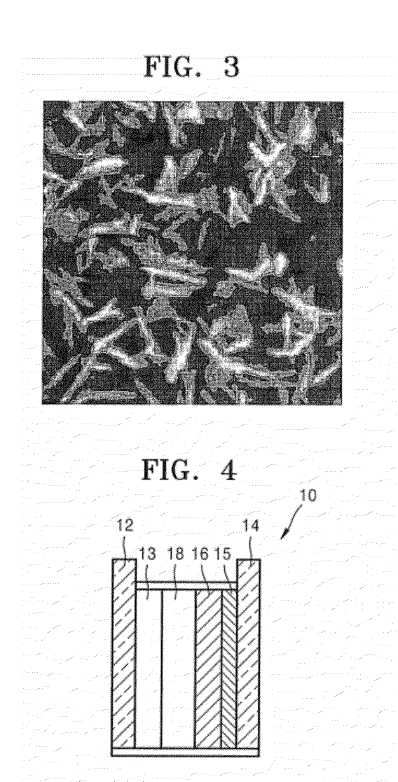

FIG. 1 is an image of a surface of lithium-aluminum-titanium-phosphate (LATP) that is a lithium ion conductive solid electrolyte according to an aspect of the invention. FIG. 2 is an image of a surface of the lithium ion conductive solid electrolyte of FIG. 1 after the lithium ion conductive solid electrolyte is immersed in 1 M of LiCl solution for three weeks. FIG. 3 is an image of a surface of the lithium ion conductive solid electrolyte of FIG. 1 after the lithium ion conductive solid electrolyte is immersed in 1 M of LiOH solution. In the LATP lithium ion conductive solid electrolyte that is immersed in the LiOH solution, hydroxyl groups of LiOH react with metal ions of the LATP lithium ion conductive solid electrolyte to generate a large amount of byproducts on a surface of the LATP lithium ion conductive solid electrolyte. However, in the LATP lithium ion conductive solid electrolyte that is immersed in the LiCl solution, few byproducts are generated.

Accordingly, by including a lithium halide in the aqueous electrolyte, the lithium ion conductive solid electrolyte membrane may be prevented (that is, protected) from decomposition. Examples of the lithium halide included in the aqueous electrolyte may include lithium fluoride (LiF), lithium chloride (LiCl), lithium bromide (LiBr), and lithium iodide (LiI), and may be used alone or in combinations of at least two thereof.

Since the lithium halide is dissolved in the aqueous electrolyte, the lithium halide may have a high concentration, for example, a saturation concentration. As an example of the saturation concentration, 0.27 g of LiF may be dissolved in 100 ml of water at a temperature of 18° C., 83.2 g of LiCl may be dissolved in 100 ml of water at a temperature of 20° C., 166.7 g of LiBr may be dissolved in 100 ml of water at a temperature of 20° C., and 433 g of LiI may be dissolved in 100 ml of water at a temperature of 20° C.

The concentration of the lithium halide dissolved in the aqueous electrolyte may be, for example, about 0.1% to about 100%, or about 10% to about 100% of the saturation concentration. For example, if LiCl having 50% of the saturation concentration is dissolved in the aqueous electrolyte, 41.6 g of LiCl is dissolved in 100 ml at a temperature of 20° C. If LiCl having 100% of the saturation concentration is dissolved in the aqueous electrolyte, 83.2 g of LiCl is dissolved in 100 ml at a temperature of 20° C.

The amount of LiCl that is the lithium halide dissolved in the aqueous electrolyte may be about 1 to about 83 parts by weight based on 100 parts by weight of water. The amount of LiF dissolved in the aqueous electrolyte may be about 0.01 to about 0.27 parts by weight based on 100 parts by weight of water. The amount of LiBr dissolved in the aqueous electrolyte may be about 1 to about 166 based on 100 parts by weight of water. The amount of LiI dissolved in the aqueous electrolyte may be about 1 to about 433 based on 100 parts by weight of water.

The lithium ion conductive solid electrolyte membrane protected by the lithium halide includes metal ions, and is disposed between the positive electrode and the negative electrode. In addition, since only lithium ions may pass through the lithium ion conductive solid electrolyte membrane, the lithium ion conductive solid electrolyte membrane may serve as a protective layer for protecting lithium included in the negative electrode from water. The lithium ion conductive solid electrolyte membrane may include an inorganic material, for example, lithium ion conductive glass, lithium-ion conductive crystal (ceramic or glass-ceramic), or a mixture thereof. To attain chemical stability, the lithium ion conductive solid electrolyte membrane may include an oxide.

When the lithium ion conductive solid electrolyte membrane includes a large amount of lithium-ion conductive crystal, high ion conductance may be obtained. For example, the lithium ion conductive solid electrolyte membrane may include lithium-ion conductive crystals having an amount of 50 wt % or more, or 55 wt % or more, based on the total weight of the lithium ion conductive solid electrolyte membrane.

Examples of the lithium-ion conductive crystal may include a crystal having a perovskite structure having lithium ion conductance, such as Li₃N, LISICON, La_{0.55}Li_{0.35}TiO₃, or the like; LiTi₂P₃O₁₂ having a NASICON-type structure; and glass-ceramic for precipitating these crystals.

The lithium-ion conductive crystal may be, for example, Li_{1+x+y}(Al, Ga)ₓ(Ti, Ge)₂₋ₓSi_{y}P_{3-y}O₁₂ (where 0≦x≦1, 0≦y≦1). For example, x and y may satisfy 0≦x≦0.4, 0<y≦0.6, or 0.1≦x≦0.3, 0.1<y≦0.4. To attain high ion conductance, the lithium-ion conductive crystal may not include a grain boundary that interrupts ion conduction. For example, since glass-ceramic may include only a trace of a pore or a grain boundary which interrupts ion conduction, high ion conductance and excellent chemical stability may be attained.

Examples of the lithium ion conductive glass-ceramic include lithium-aluminum-germanium-phosphate (LAGP), lithium-aluminum-titanium-phosphate (LATP), lithium-aluminum-titanium-silicon-phosphate (LATSP), and the like.

For example, when a mother glass includes a composite of Li₂O—Al₂O₃—TiO₂—SiO₂—P₂O₅ (LATSP), and the mother glass is heat-treated and crystallized, the main crystalline phase is Li_{1+x+y}AlₓTi₂₋ₓSi_{y}P_{3-y}O₁₂ (0≦x≦1, and 0≦y≦1), where x and y satisfy, for example, 0≦x≦0.4 and 0<y≦0.6, or 0.1≦x≦0.3 and 0.1<y≦0.4.

In this case, the pores and the grain boundary that interrupt ion conduction refer to materials that interrupt ion conduction that reduces the total ion conductance of an inorganic material including a lithium ion conductive crystal to 1/10 of the ion conductance of the lithium ion conductive crystal itself or less.

The glass-ceramic refers to a material obtained by heat-treating glass to precipitate crystalline phases from glass phases, and includes amorphous solid and crystal. In addition, the glass-ceramic may include a material in which the phase is transitioned from all glass phases to crystalline phases, for example, such as a material having crystallization of 100 wt % based on the material. Although a material may have crystallization of 100 wt % based on the material, only a trace of pores may exist between crystalline particles, or within crystals, in glass-ceramic.

Since the lithium ion conductive solid electrolyte membrane includes a large amount of glass-ceramic, high ion conductance may be attained. Thus, 80 wt % of lithium ion conductive glass-ceramic or more may be included in the lithium ion conductive solid electrolyte membrane. In order to further increase ion conductance, the amount of the lithium ion conductive glass-ceramic included in the lithium ion conductive solid electrolyte membrane may be 85 wt % or more, or 90 wt % or more.

Li₂O components included in the glass-ceramic provide carriers of Li⁺ ions, and are useful to attain lithium ion conductance. In order to easily attain high ion conductance, the amount of the Li₂O components may be, for example, 12% or more, 13% or more, or 14%. If there is an excessively high amount of the Li₂O components, the thermal stability of the glass may be easily reduced, and conductance of the glass-ceramic may be easily reduced. Thus, the upper limit of the amount of the Li₂O components may be 18%, 17% or 16%.

Al₂O₃ components included in the glass-ceramic may improve thermal stability of the mother glass. Simultaneously, Al³⁺ ions are made to form a solid solution in the crystalline phase, thereby improving lithium ion conductance. In order to further attain this effect, a lower limit of the amount of the Al₂O₃ components may be 5%, 5.5%, or 6%. However, if the amount of the Al₂O₃ components exceeds 10%, the thermal stability of the glass may deteriorate easily, and the conductance of the glass-ceramic may also be reduced. Thus, the upper limit of an amount of the Al₂O₃ components may be 10%, 9.5%, or 9%.

TiO₂ components included in the glass-ceramic may facilitate the formation of glass, may constitute the crystalline phase, and may be useful in glass and crystal. To change the crystalline phase to the glass phase, the crystalline phase is the main phase, and is precipitated from the glass. In order to easily attain high ion conductance, the lower limit of the amount of the TiO₂ components may be 35%, 36%, or 37%. If the TiO₂ components have an excessively high amount, the thermal stability of the glass may be easily reduced, and the conductance of the glass-ceramic may be easily reduced. Thus, the upper limit of the amount of the TiO₂ components may be 45%, 43%, or 42%.

SiO₂ components included in the glass-ceramic may improve the melting characteristics and thermal stability of the mother glass. Simultaneously, Si⁴⁺ ions are made to form a solid solution in the crystalline phase, thereby improving lithium ion conductance. In order to further attain this effect, the lower limit of the amount of the SiO₂ components may be 1%, 2%, or 3%. However, if the amount of the SiO₂ components is excessively high, conductance is reduced. Thus, the upper limit of the amount of the SiO₂ components may be 10%, 8%, or 7%.

P₂O₅ components included in the glass-ceramic may be useful to form glass, and may constitute the crystalline phase. When the amount of the P₂O₅ components is 30% or less, it is difficult to change the crystalline phase to the glass phase. Thus, the lower limit of the P₂O₅ components may be 30%, 32%, or 33%. If the amount of the P₂O₅ components exceeds 40%, it is difficult to precipitate the crystalline phase from the glass, and it is difficult to attain the desired property. Thus, the upper limit of the amount of the P₂O₅ components may be 40%, 39%, or 38%.

When the above-described composites are used, glass may be easily obtained by casting melted glass. Glass-ceramic having the glass phase obtained by heat-treating the glass may have a high lithium ion conductance of 1×10⁻³ S·cm⁻¹.

Other than the above-described composites, if glass-ceramic has a crystalline structure similar to the above-described composites, Al₂O₃ components may be entirely or partially substituted by Ga₂O₃ components, and TiO₂ components may be entirely or partially substituted by GeO₂ components. In addition, when the glass-ceramic is prepared, in order to reduce the melting point of the glass-ceramic or to improve the stability of the glass, a trace of other materials may be added as long as ion conductance may not be seriously reduced.

In some embodiments, the lithium ion conductive solid electrolyte membrane may further include a high-molecular weight solid electrolyte in addition to the glass-ceramic. The high-molecular weight solid electrolyte may be polyethylene oxide doped with a lithium salt. Examples of the lithium salt include LiN(SO₂CF₂CF₃)₂, LiBF₄, LiPF₆, LiSbF₆, LiAsF₆, LiClO₄, LiCF₃SO₃, LiN(SO₂CF₃)₂, LiN(SO₂C₂F₅)₂, LiC(SO₂CF₃)₃, LiN(SO₃CF₃)₂, LiC₄F₉SO₃, LiAlCl₄, and the like.

The high-molecular weight solid electrolyte and the glass-ceramic may constitute a stack structure. The glass-ceramic may be placed between a first high-molecular weight solid electrolyte and a second high-molecular weight solid electrolyte that includes the above-described composite.

As described above, the lithium ion conductive solid electrolyte membrane is formed on one surface of a negative electrode in which ions are intercalatable and deintercalatable, and protects the negative electrode so as to prevent the negative electrode from reacting with the aqueous electrolyte. Thus, only lithium ions may be passed through the lithium ion conductive solid electrolyte membrane.

The negative electrode that absorbs and releases lithium ions may include at least one material selected from the group consisting of lithium metal, a lithium metal-based alloy, and a lithium intercalating compound. For example, the lithium metal-based alloy may include an alloy of aluminum, tin, magnesium, indium, calcium, titanium, vanadium, or a combination thereof and lithium.

A lithium air battery according to an embodiment of the present invention may further include a non-aqueous electrolyte between the negative electrode in which ions are intercalatable and deintercalatable and the lithium ion conductive solid electrolyte membrane. The non-aqueous electrolyte may serve as a medium through which ions may participate in electrochemical reactions of the lithium air battery.

The non-aqueous electrolyte may use an organic solvent. Examples of the non-aqueous organic solvent may include carbonate solvents, ester solvents, ether solvents, ketone solvents, organosulfur solvents, organophosphorus solvents, or aprotic solvents. Examples of the carbonate solvents may include dimethyl carbonate (DMC), diethyl carbonate (DEC), ethyl methyl carbonate (EMC), dipropyl carbonate (DPC), methyl propyl carbonate (MPC), ethyl propyl carbonate (EPC), ethylene carbonate (EC), propylene carbonate (PC), fluoroethylene carbonate (FEC), butylene carbonate (BC), or the like. Examples of the ester solvents may include methyl acetate, ethyl acetate, n-propyl acetate, 1,1-dimethylethyl acetate, methyl propionate, ethyl propionate, γ-butyrolactone, decanolide, valerolactone, mevalonolactone, caprolactone, or the like. Examples of the ether solvents may include dibutyl ether, tetraglyme, diglyme, dimethoxyethane, 2-methyltetrahydrofuran, tetrahydrofuran, or the like. Examples of the ketone solvents may include cyclohexanone, or the like. Examples of the organosulfur solvents may include methanesulfonyl chloride or the like. Examples of the organophosphorus solvents may include p-trichloro-n-dichlorophosphorylmonophosphazene, or the like. Examples of the aprotic solvents may include nitriles such as R—CN (R is a C₂-C₂₀ linear, branched or cyclic hydrocarbon group, and R—CN may have a double-bond aromatic ring, or ether bond), amides such as dimethylformamide, dioxolanes such as 1,3-dioxolane, sulfolanes, or the like.

The nonaqueous organic solvent may be used alone. Alternatively, at least two of the nonaqueous organic solvents may be used in combination. In this case, the mixing ratio of the at least two nonaqueous organic solvents may appropriately vary according to the desired performance of the battery, and can be determined by one of ordinary skill in the art.

The nonaqueous solvent may include a lithium salt. The lithium salt may be dissolved in the organic solvent to be a source of lithium ions in a battery, for example, to facilitate migration of lithium ions between the negative electrode and the lithium ion conductive solid electrolyte membrane. The lithium salt may include at least one salt selected from the group consisting of LiPF₆, LiBF₄, LiSbF₆, LiAsF₆, LiN(SO₂C₂F₆)₂, Li(CF₃SO₂)₂N, LiC₄F₉SO₃, LiClO₄, LiAlO₂, LiAlCl₄, LiN(CₓF₂ₓ₊₁SO₂)(C_{y}F_{2y+1}SO₂), where x and y are respectively a natural number, LiF, LiBr, LiCl, LiI, and LiB(C₂O₄)₂ (also known as lithium bis(oxalato) borate or LiBOB). The concentration of the lithium salt may be in the range of about 0.1 to about 2.0 M. When the concentration of the lithium salt is within this range, the electrolyte may have an appropriate conductivity and viscosity, and thus may exhibit excellent performance, allowing lithium ions to effectively migrate.

The nonaqueous organic solvent may further include another metal salt such as AlCl₃, MgCl₂, NaCl, KCl, NaBr, KBr, and CaCl₂ in addition to the lithium salt.

The positive electrode using oxygen as a positive active material may use any porous and conductive material. For example, porous carbonaceous materials may be used to form the positive electrode. Examples of the carbonaceous material may include carbon black, graphite, graphene, active carbon, carbon fabric, or the like.

A catalyst for reduction of oxygen may be further added to the positive electrode. Examples of the catalyst may include a precious metal catalyst such as platinum (Pt), gold (Au), silver (Ag), palladium (Pd), ruthenium (Ru), rhodium (Rh), or osmium (Os); an oxide catalyst such as a manganese oxide, an iron oxide, a cobalt oxide, or a nickel oxide; or an organic metal catalyst such as cobalt phthalocyanine.

In addition, a separator may be disposed between the negative electrode and the positive electrode. The separator may be any separator having a composition which may be used in the lithium air battery. For example, a polymer non-woven fabric such as a polypropylene non-woven fabric or a polyphenylene sulfide non-woven fabric, a porous film of an olefin resin such as polyethylene or polypropylene, or a combination of at least two thereof may be used.

The aqueous electrolyte is placed between the negative electrode having one surface on which the lithium ion conductive solid electrolyte membrane is formed, and the positive electrode that uses oxygen as a positive active material. The aqueous electrolyte may use water as a main solvent, and include a lithium halide. In addition, the concentration of lithium hydroxide dissolved in the aqueous electrolyte may be changed according to the reaction mechanism of the lithium air battery.

Although it was described that the above aqueous electrolyte is interposed between the lithium ion conductive solid electrolyte membrane and the positive electrode, the aqueous electrolyte may instead be partially or fully impregnated in the positive electrode since the aqueous electrolyte is a liquid instead of a solid. When the separator is also provided, the electrolyte may instead be impregnated in the separator.

The term “air” used herein is not limited to atmosphere, and may include a composition of air including oxygen or pure oxygen gas. The wide definition of the term “air” may also be applied to, for example, an air battery, an air positive electrode, or the like.

The lithium air battery may be a lithium primary battery or a lithium secondary battery. In addition, the lithium air battery is not particularly limited in shape, and the shape of the lithium air battery may be, for example, a coin-type, a button-type, a sheet-type, a laminated-type, a cylindrical-type, a flat-type, or a horn-type. In addition, the lithium air battery 10 (see FIG. 4 described below) may be used in a large battery for electric vehicles.

FIG. 4 is a schematic diagram of a lithium air battery 10 according to an embodiment of the present invention. In the lithium air battery 10, a positive electrode 13 is formed on a first current collector 12 and uses oxygen as an active material. An aqueous electrolyte 18 is disposed between the positive electrode 13 and a lithium ion conductive solid electrolyte membrane 16. The lithium ion conductive solid electrolyte membrane 16 is formed on one surface of a negative electrode 15. The negative electrode 15 is adjacent to a second current collector 14 and the negative electrode 15 is one in which lithium ions are intercalatable and deintercalatable. A separator (not shown) may be disposed between the lithium ion conductive solid electrolyte membrane 16 and the positive electrode 13.

Hereinafter, one or more embodiments of the present invention will be described in detail with reference to the following examples. However, these examples are not intended to limit the purpose and scope of the one or more embodiments of the present invention.

### Comparative Example 1

Lithium hydroxide was added to 20 mL of water to obtain a solution of 5M lithium hydroxide, and the pH of the solution was measured by a pH meter.

### Example 1

Lithium chloride was added and then lithium hydroxide was added to 20 mL of water to obtain a solution of 1M lithium chloride and 5M lithium hydroxide. The pH of the solution was measured by a pH meter.

### Example 2

Lithium chloride was added and then lithium hydroxide was added to 20 mL of water to obtain a solution of 3M lithium chloride and 5M lithium hydroxide. The pH of the solution was measured by a pH meter.

### Example 3

Lithium chloride was added and then lithium hydroxide was added to 20 mL of water to obtain a solution of 5M lithium chloride and 5M lithium hydroxide. The pH of the solution was measured by a pH meter.

### Example 4

Lithium chloride was added and then lithium hydroxide was added to 20 mL of water to obtain a solution of 8M lithium chloride and 5M lithium hydroxide. The pH of the solution was measured by a pH meter.

### Example 5

Lithium chloride was added and then lithium hydroxide was added to 20 mL of water to obtain a solution of 10M lithium chloride and 5M lithium hydroxide. The pH of the solution was measured by a pH meter.

### Example 6

Lithium chloride was added and then lithium hydroxide was added to 20 mL of water to obtain a solution of 15M lithium chloride and 5M lithium hydroxide. The pH of the solution was measured by a pH meter.

### Example 7

20 mL of water was saturated with lithium chloride and then lithium hydroxide was added to obtain a solution of saturated lithium chloride and 5M lithium hydroxide. Then, the pH of the solution was measured by a pH meter.

### Experimental Example 1

The pH measurement results of Comparative Example 1 and Examples 1 through 7 are shown in Table 1 below.

TABLE 1

| | LiOH | LiCl | |
|---|---|---|---|
| | Concentration | Concentration | |
| Division | (M) | (M) | pH |
| Comparative Example 1 | 5 | 0 | 14.03 |
| Example 1 | 5 | 1 | 11.73 |
| Example 2 | 5 | 3 | 11.37 |
| Example 3 | 5 | 5 | 10.72 |
| Example 4 | 5 | 8 | 9.96 |
| Example 5 | 5 | 10 | 9.36 |
| Example 6 | 5 | 15 | 8.55 |
| Example 7 | 5 | Saturation | 8.14 |

As shown in Table 1, as the concentration of LiCl was increased in Examples 1 through 7, the pH of a solution is reduced. Thus, as LiCl was added, the degree of dissociation of 5 M of LiOH was reduced.

### Preparation Example 1

### Lithium Ion Conductive Solid Electrolyte Membrane

Reagent grades of bis(trifluoromethanesulfonyl)imide (LiTFSI, available from Aldrich), polyethylene oxide (whose molecular weight is 600,000, Aldrich), and acetonitrile (CAN, Aldrich were used. 0.5 g of LiTFSI was dissolved in 50 mL of acetonitrile. 1.4 g of PEO was added to the resultant, and was stirred for 12 hours. Then, the resulting solution was put on a PTFE plate, was dried for 24 hours at 40° C. in a nitrogen atmosphere, and was vacuum-dried for 24 hours at 150° C. to prepare a lithium ion conductive solid electrolyte membrane. The lithium ion conductive solid electrolyte membrane was cut to have a size 1.5 cm×1.5 cm.

### Preparation Example 2

### Protected Lithium Negative Electrode

An aluminum film of which part is formed of LATP was prepared by forming a hole having a size of 1 cm×1 cm in the center of a polypropylene coated aluminum film (200 μm) having a size of 5 cm×5 cm and then filling the hole with a LATP film (whose thickness is 150 μm, Ohara corporation) by using adhesives. An aluminum pouch-type protected lithium negative electrode was prepared by stacking a new aluminum film having a size of 5 cm×5 cm, a copper current collector (whose thickness was 20 μm), a lithium foil (whose size and thickness were 1.4 cm×1.4 cm, and 100 μm, respectively), the lithium ion conductive solid electrolyte membrane prepared in Preparation Example 1, and the above aluminum film, and then heat-adhering the resulting structure in a vacuum.

### Example 8

Lithium hydroxide and lithium chloride were saturated in 20 mL of water. A LATP solid electrolyte membrane having a size of 1 cm×1 cm was immersed in the saturated solution. The resultant was maintained for 3 weeks at a temperature of 50° C.

### Example 9

Lithium hydroxide was added to 20 mL of water to obtain a solution of 0.01M lithium hydroxide, and then lithium chloride was saturated. A LATP solid electrolyte membrane having a size of 1 cm×1 cm was immersed in the saturated solution. The resultant was maintained for three weeks at a temperature of 50° C.

### Example 10

Lithium hydroxide was added to 20 mL of water to obtain a solution of 0.01M lithium hydroxide, and then lithium chloride was saturated. A LATP solid electrolyte membrane having a size of 1 cm×1 cm was immersed in the saturated solution. The resultant was maintained for three weeks at a temperature of 50° C.

### Comparative Example 2

Lithium hydroxide was added to 20 mL of water to obtain a solution of 0.01M lithium hydroxide. A LATP solid electrolyte membrane having a size of 1 cm×1 cm was immersed in the resulting solution. The resultant was maintained for three weeks at a temperature of 50° C.

### Comparative Example 3

Lithium hydroxide was added to 20 mL of water to obtain a solution of 0.001M lithium hydroxide. A LATP solid electrolyte membrane having a size of 1 cm×1 cm was immersed in the resulting solution. The resultant was maintained for three weeks at a temperature of 50° C.

### Comparative Example 4

Lithium hydroxide was added to 20 mL of water to obtain a solution of 1M lithium hydroxide. A LATP solid electrolyte membrane having a size of 1 cm×1 cm was immersed in the resulting solution. The resultant was maintained for three weeks at a temperature of 50° C.

### Comparative Example 5

Lithium hydroxide was added to 20 mL of water to obtain a solution of 1M lithium hydroxide. A LATP solid electrolyte membrane having a size of 1 cm×1 cm was immersed in the resulting solution. The resultant was maintained for six weeks at a temperature of 50° C.

### Experimental Example 2

LATP films that are the resultants prepared in Examples 8 through 10 and Comparative Examples 2 through 5 were washed with clean water, and then gold (Au) was coated on two surfaces of each LATP film to have a thickness of 100 nm by using a sputtering method. Then, aluminum pouch type symmetrical cells using a Cu foil as a current collector were manufactured. Electrical conductivities of the aluminum pouch type symmetrical cells were measured at a temperature of 25° C. The measurement results are shown in Table 2 below.

TABLE 2

| | LiOH | LiCl | |
|---|---|---|---|
| | Concentration | Concentration | Conductivity |
| Division | (M) | (M) | (25° C., Scm⁻¹) |
| Example 8 | Saturation | Saturation | 2.28 × 10⁻⁴ |
| Example 9 | 0.01 | Saturation | 2.30 × 10⁻⁴ |
| Example 10 | 0.001 | Saturation | 2.30 × 10⁻⁴ |
| Comparative | 0.01 | 0 | 1.40 × 10⁻⁴ |
| Example 2 | | | |
| Comparative | 0.001 | 0 | 1.76 × 10⁻⁴ |
| Example 3 | | | |
| Comparative | 1 | 0 | 2.30 × 10⁻⁵ |
| Example 4 | | | |
| Comparative | 1 | 0 | 5.20 × 10⁻⁷ |
| Example 5 | | | |
| Non-treated | — | — | 2.37 × 10⁻⁴ |
| LATP | | | |

As shown in Table 2, in Comparative Examples 2 through 5 where only lithium hydroxide is added to solutions, the conductivities are reduced due to a reaction between lithium hydroxide and the solid electrolyte membrane. However, in Examples 8 through 10 where lithium hydroxide and lithium chloride are added to solutions, the conductivities are only slightly reduced.

### Experimental Example 3

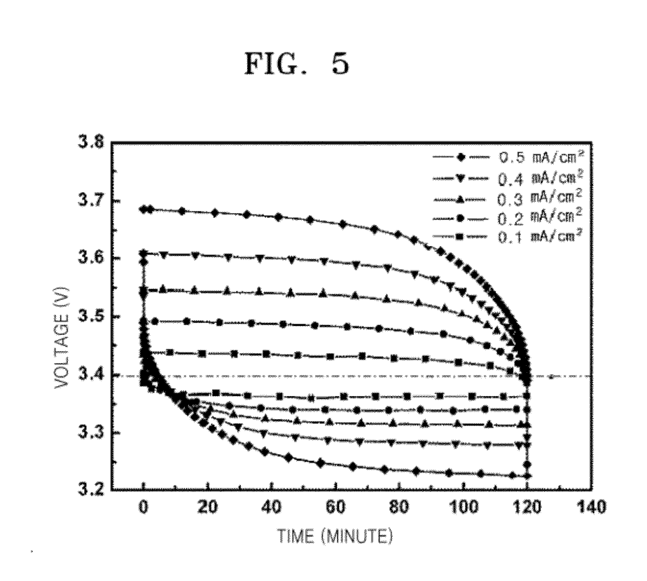

Potential differences of lithium batteries using the protected lithium negative electrode prepared in Preparation Example 2 as a negative electrode, 1 M of LiCl as an aqueous electrolyte, and Pt-black as a positive electrode were measured according to time at a temperature of 60° C. with current densities of 0.1, 0.2, 0.3, 0.4, and 0.5 mA/cm². The measurement results are shown in FIG. 5. As shown in FIG. 5, the lithium batteries may attain sufficient potential differences with various current densities.

As described above, according to the one or more of the above embodiments of the present invention, a lithium air battery using an aqueous electrolyte may have improved durability by preventing a solid electrolyte from being decomposed due to reaction products, thereby increasing energy density and improving life characteristics.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A lithium air battery comprising:
a negative electrode in which lithium ions are intercalatable and deintercalatable;
a lithium ion conductive solid electrolyte membrane;
an aqueous electrolyte; and
a positive electrode using oxygen as a positive active material,
wherein the aqueous electrolyte includes lithium hydroxide and a lithium halide.

2. The lithium air battery of claim 1, wherein the lithium halide comprises at least one halide selected from the group consisting of lithium fluoride (LiF), lithium chloride (LiCl), lithium bromide (LiBr), and lithium iodide (LiI).

3. The lithium air battery of claim 1, wherein the lithium ion conductive solid electrolyte membrane is disposed between the negative electrode and the positive electrode, and is formed on one surface of the negative electrode.

4. The lithium air battery of claim 1, wherein the lithium ion conductive solid electrolyte membrane comprises a glass-ceramic solid electrolyte comprising a metal ion.

5. The lithium air battery of claim 4, wherein the lithium ion conductive solid electrolyte membrane further comprises a high-molecular weight solid electrolyte.

6. The lithium air battery of claim 1, wherein the lithium ion conductive solid electrolyte membrane comprises a stack structure of a glass-ceramic solid electrolyte and a high-molecular weight solid electrolyte.

7. The lithium air battery of claim 1, wherein the lithium halide dissolved in the aqueous electrolyte has a concentration of about 0.1% to about 100% of the saturation concentration.

8. The lithium air battery of claim 1, wherein the lithium halide dissolved in the aqueous electrolyte has a concentration of about 10% to about 100% of the saturation concentration.

9. The lithium air battery of claim 1, wherein the aqueous electrolyte comprises lithium chloride (LiCl) having an amount of about 1 to about 83 parts by weight based on 100 parts by weight of water.

10. The lithium air battery of claim 1, wherein the negative electrode comprises lithium metal, a lithium metal-based alloy, or a lithium intercalating compound.

11. The lithium air battery of claim 1, wherein the positive electrode comprises a porous carbonaceous material.

12. The lithium air battery of claim 1, further comprising a separator disposed between the lithium ion conductive solid electrolyte membrane and the positive electrode.

13. The lithium air battery of claim 1, wherein the positive electrode further comprises an oxygen reduction catalyst.

14. The lithium air battery of claim 1, wherein the aqueous electrolyte is disposed between the lithium ion conductive solid electrolyte membrane and the positive electrode.

15. The lithium air battery of claim 1, wherein the aqueous electrolyte is entirely or partially impregnated in the positive electrode.

16. The lithium air battery of claim 1, further comprising a non-aqueous electrolyte disposed between the negative electrode and the lithium ion conductive solid electrolyte membrane.
